(19) United States
(12) Patent Application Publication
(10) Pub. No.: US 2016/0002062 A1
(43) Pub. Date: Jan. 7, 2016

(54) PROCESS FOR PRODUCING HEAT-RESISTANT ALUMINUM HYDROXIDE

(71) Applicant: SUMITOMO CHEMICAL COMPANY, LIMITED, Tokyo (JP)

(72) Inventors: Tomoyuki KITA, Niihama-shi (JP); Yoji MATSUO, Niihama-shi (JP); Yusuke KAWAMURA, Tokyo (JP)

(73) Assignee: SUMITOMO CHEMICAL COMPANY, LIMITED, Tokyo (JP)

(21) Appl. No.: 14/770,221

(22) PCT Filed: Feb. 20, 2014
(86) PCT No.: PCT/JP2014/054784

§ 371 Date: Aug. 25, 2015

(30) Foreign Application Priority Data
Feb. 26, 2013 (JP) 2013-036055
Jun. 14, 2013 (JP) 2013-125733

(51) Int. Cl. C01F 7/02; C08K 3/22

(52) U.S. Cl. CPC C01F 7/021; C08K 3/22; C01P 2006/13; C08K 2003/2227

(57) ABSTRACT

A process for producing a heat-resistant aluminum hydroxide, comprising the step of applying a heating treatment to a gibbsite-type aluminum hydroxide at a pressure equal to or higher than an atmospheric pressure and equal to or lower than 0.3 MPa, in an atmosphere whose water vapor molar fraction is equal to or higher than 0.03 and equal to or lower than 1, and at a temperature equal to or higher than 180° C. and equal to or lower than 300° C.

### TECHNICAL FIELD

The present invention relates to a process for producing an aluminum hydroxide having high heat resistance and, more particularly, to a process comprising the step of applying a heating treatment to a gibbsite-type aluminum hydroxide produced using a Bayer process, under the conditions of a pressure equal to or higher than the atmospheric pressure and equal to or lower than 0.3 MPa and a water vapor molar fraction of equal to or higher than 0.03 and equal to or lower than one. The present invention also relates to an aluminum hydroxide having high heat resistance and an aluminum hydroxide having high heat resistance and a high insulation property.

### BACKGROUND ART

A gibbsite-type aluminum hydroxide is dehydrated by heating water included in the crystal thereof. By using this mechanism, the gibbsite-type aluminum hydroxide is used as a flame retarder to impart a flame retardant property to a resin. A resin composition obtained by blending the gibbsite-type aluminum hydroxide in a resin is used in an electronic part such as a printed circuit board, an electric cable covering material, an insulating material, etc. On the other hand, the gibbsite-type aluminum hydroxide starts its dehydration at about 230° C. This dehydration region may correspond to a temperature range to process the resin. It may therefore be difficult to use the gibbsite-type aluminum hydroxide as a flame retarder.

The following two types of dehydration are known as the dehydration of the gibbsite-type aluminum hydroxide that occurs when the gibbsite-type aluminum hydroxide is gradually heated in the atmospheric air.

Al₂O₃.3H₂O→Al₂O₃.H₂O+2H₂O (1)

Al₂O₃.3H₂O→Al₂O₃+3H₂O (2)

(1) expresses dehydration from the gibbsite to a boehmite that is a monohydrate and (2) expresses dehydration to alumina. The dehydration of (1) generally tends to occur from the low temperature side (about 220° C.) and (2) starts simultaneously with (1) or from the high temperature side (about 230° C.). Such operation has therefore been conducted to improve the heat resistance of the aluminum hydroxide, as that the aluminum hydroxide is in advance applied with a heating treatment under various conditions and the dehydration occurring on the low temperature side is thereby in advance caused to progress.

For example, Patent Document 1 discloses a method in which an aluminum hydroxide and a reaction retarder to delay the transition to a boehmite are mixed with each other, and the mixture is hydrothermally treated in a pressure container or is pressured and heated in a water vapor atmosphere. This document also discloses that, according to this method, the heat resistance of the aluminum hydroxide is improved because a thermal history can be imparted thereto suppressing the transition to the boehmite to only partial occurrence in an environment for the aluminum hydroxide to normally change its phase completely to the boehmite.

Patent Document 2 discloses that an aluminum hydroxide excellent in the heat resistance represented by Al₂O₃.nH₂O, wherein n is 1.8 to 2.7, can be obtained by partially dehydrating in advance by applying a heating treatment to an aluminum hydroxide having the average particle diameter of 0.3 to 4.5 μm.

Patent Document 3 discloses a method in which χ-alumina is produced by applying a heating treatment to aluminum hydroxide particles in the atmospheric air and at 230 to 270° C. to obtain an aluminum hydroxide excellent in the heat resistance. In an Example of Patent Document 3, a method is disclosed according to which a heating treatment is applied to CL-303 produced by Sumitomo Chemical Co., Ltd., at 260° C. for 30 min as a residence time using a disc dryer.

### PRIOR ART DOCUMENT

### Patent Document

Patent Document 1: International Patent Publication No. 2004/080897

Patent Document 2: Japanese Patent Publication No. 2002-211918

Patent Document 3: Japanese Patent Publication No. 2011-84431

### SUMMARY OF THE INVENTION

### Problems to Be Solved By the Invention

However, the method of Patent Document 1 needs pressurizing, and thus the thermal process needs to be conducted in an expensive pressure container. Addition of another compound is necessary as the reaction retarder, and an increase of the cost occurs due to the addition of the compound. The surface of the aluminum hydroxide is covered with the reaction retarder and this causes a change of the powder physical property and a change of the compatibility with the resin.

It is known that, when the dehydration is conducted using the heating treatment in the atmospheric air using the method of each of Patent Documents 2 and 3, the dehydration progresses from the surface, faults are generated in the outermost surface at the atomic level, and further progress of the dehydration results in production of χ-alumina with a large surface area. When the surface area is increased, the moisture in the air is adsorbed and a small-scale dehydration may occur from the low temperature side. The adsorption of the moisture may influence degradation of the insulation property acquired when the aluminum hydroxide is blended in a resin. On the contrary, even when the heating treatment is conducted at a temperature of about 200° C., the heating treatment taking a long time is necessary to establish a sufficient thermal history to the powder. As a result, faults in the surface are increased. With this method, it is difficult to impart a high thermal history suppressing the faults in the surface of the aluminum hydroxide. With this method, improvement of the heat resistance using the heating treatment is therefore limited.

As above, with the traditional methods, the dehydration is partially achieved by the heating treatment while no aluminum hydroxide can be obtained whose outermost surface has few faulted portions and whose heat resistance is high.

### Means for Solving the Problems

An object of the present invention is to provide a process for producing an aluminum hydroxide that is tolerant to the process temperature of a resin, by imparting a high thermal history thereto suppressing any fault and any dehydration in the surface.

The present invention includes the following configurations.
(1) A process for producing a heat-resistant aluminum hydroxide, comprising the step of

applying a heating treatment to a gibbsite-type aluminum hydroxide at a pressure equal to or higher than an atmospheric pressure and equal to or lower than 0.3 MPa, in an atmosphere whose water vapor molar fraction is equal to or higher than 0.03 and equal to or lower than 1, and at a temperature equal to or higher than 180° C. and equal to or lower than 300° C.
(2) The process according to the above item (1), wherein the gibbsite-type aluminum hydroxide is produced using Bayer process.
(3) The process according to the above item (1), wherein a time period to conduct the heating treatment is equal to or longer than 1 min and equal to or shorter than 360 min.
(4) The process according to the above item (1), wherein the heating treatment is applied to 100 parts by weight of the gibbsite-type aluminum hydroxide together with 0.1 part by weight or more and 5 parts by weight or less of silicon compound in terms of SiO₂.
(5) The process according to the above item (1), wherein the silicon compound is a monomer of a silicate represented by a general formula Si(OR)₄,

wherein R is an alkyl group having 1 or 2 carbon atoms, a polymer thereof, or a hydrolysis product and/or a condensation product thereof.
(6) A heat-resistant aluminum hydroxide, wherein BET specific surface area is equal to or larger than 1.5 m²/g and equal to or smaller than 8 m²/g, and area intensity ratio of oxygen and aluminum (O1s/Al2p) measured using an X-ray photoelectron spectroscopy is equal to or greater than 2.55 and equal to or smaller than 2.85.
(7) The heat-resistant aluminum hydroxide according to the above item (6), wherein a boehmite content is equal to or higher than 3% and equal to or lower than 13%.
(8) A heat-resistant aluminum hydroxide, wherein BET specific surface area is equal to or larger than 1.5 m²/g and equal to or smaller than 8 m²/g, a boehmite content is equal to or higher than 3% and equal to or lower than 13%, and whose Na1s bond energy in a surface thereof measured using an X-ray photoelectron spectroscopy has a local maximal value in a range equal to or higher than 1,071.0 eV and equal to or lower than 1,072.0 eV.
(9) The heat-resistant aluminum hydroxide according to the above item (8), wherein a total sodium content in terms of Na₂O is equal to or higher than 0.01% by weight and equal to or lower than 0.05% by weight.
(10) A resin composition comprising the heat-resistant aluminum hydroxide according to any one of the above items (6) to (9).

### Effect of the Invention

According to the process of the present invention, a highly heat-resistant aluminum hydroxide can be produced that is tolerant to the process temperature for a resin, by imparting a high thermal history to the aluminum hydroxide suppressing any faults and any dehydration in the surface of the aluminum hydroxide.

### MODES FOR CARRYING OUT THE INVENTION

An embodiment of the present invention will be described below in detail.

A process for producing a heat-resistant aluminum hydroxide of the present invention (hereinafter, also referred to as “the process of the present invention”) includes application of a heating treatment to a gibbsite-type aluminum hydroxide at a pressure equal to or higher than the atmospheric pressure and equal to or lower than 0.3 MPa, and in an atmosphere whose water vapor molar fraction is equal to or higher than 0.03 and equal to or lower than one.

Any dehydration toward alumina and any increase of the BET specific surface area attributed to the dehydration can significantly be suppressed by applying the heating treatment to the gibbsite-type aluminum hydroxide at a pressure equal to or higher than the atmospheric pressure and equal to or lower than 0.3 MPa and in an atmosphere whose water vapor molar fraction is equal to or higher than 0.03 and equal to or lower than one. An aluminum hydroxide can therefore be obtained whose outermost surface has few faulted portions and whose heat resistance is high.

The pressure employed to conduct the heating treatment is equal to or higher than the atmospheric pressure and equal to or lower than 0.3 MPa. When the pressure is high during the heating, the transition to boehmite may progress and, preferably, the pressure is therefore set to be as low as possible.

The pressure is therefore equal to or lower than 0.3 MPa and is, preferably, equal to or lower than 0.2 MPa. For example, the pressure is substantially equal to a pressure difference generated when the water vapor is introduced into a heating apparatus.

The heating treatment is conducted in an atmosphere including moisture whose water vapor molar fraction is equal to or higher than 0.03 and equal to or lower than one. Preferably, the atmosphere is an inert gas atmosphere. When the water vapor molar fraction is one, the heating treatment is conducted in a water vapor of 100%. When the water vapor molar fraction is lower than 0.03, excessive dehydration progresses from the outermost surface before the thermal history is imparted up to the inside of each particle, and the heat resistance cannot sufficiently be improved. Setting the water vapor molar fraction to be a value equal to or higher than 0.03 may be conducted after the powder temperature of the gibbsite-type aluminum hydroxide reaches a temperature equal to or higher than 180° C. or may be conducted before the heating. When the water vapor molar fraction temporarily becomes lower than 0.03 in the course of the heating treatment, the dehydration immediately progresses from the outermost surface and, preferably, the water vapor molar fraction is therefore maintained to be equal to or higher than 0.03 until the powder is collected.

The water vapor molar fraction can be calculated from the volumes of the water vapor and the inert gas supplied at the predetermined thermal treatment temperature and the molar weights of the water and the inert gas, from an equation of (the molar concentration of the water vapor)/[(the molar concentration of the water vapor)+(the molar concentration of the inert gas)]. The inert gas can be air or nitrogen. Preferably, the inert gas is air. It is assumed herein that the molar weight of air is 29.

The temperature to conduct the heating treatment is equal to or higher than 180° C. and equal to or lower than 300° C., preferably equal to or higher than 200° C. and equal to or lower than 280° C., and more preferably equal to or higher than 220° C. and equal to or lower than 260° C. The temperature of the powder is increased to a temperature equal to or higher than 180° C. and equal to or lower than 300° C. by heating the powder under this temperature condition. In the case where the temperature of the heating treatment is lower than 180° C., the improvement of the heat resistance is limited even when the heating treatment is conducted for a long time. On the other hand, in the case where the temperature is higher than 300° C., suppression of dehydration toward alumina is difficult even under the condition where the water vapor is present, and this causes an increase of the BET specific surface area and degradation of the heat resistance.

The time period to conduct the heating treatment is preferably equal to or longer than one min and equal to or shorter than 360 min, and more preferably equal to or longer than 10 min and equal to or shorter than 240 min. As to the time period to conduct the heating treatment, the optimal time period differs depending also on the heating temperature and the water vapor molar fraction, and the time period may properly be adjusted.

In the heating treatment, sodium may move from the inside of each of the aluminum hydroxide particles to the surface of each of the particles and may become soluble sodium. This increase of soluble sodium dose not degrade the heat resistance of the aluminum hydroxide itself while the electric conductivity of the aluminum hydroxide is increased due to the presence of soluble sodium in the surface of the particle. Preferably, for the uses each requiring an insulation property, the electric conductivity is reduced. In this case, only the electric conductivity can be reduced without degrading the heat resistance by applying the heating treatment to the aluminum hydroxide together with a silicon compound.

The silicon compound can be, for example, a powder silicon compound such as silica, sodium hexafluorosilicate, or potassium hexafluorosilicate, or a liquid silicon compound such as a silicate or silicone.

Preferably, silica powder is used as the powder silicon compound. The BET specific surface area is preferably equal to or larger than 5 m²/g and equal to or smaller than 300 m²/g, and more preferably equal to or larger than 30 m²/g and equal to or smaller than 250 m²/g. When the BET specific surface area is smaller than 5 m²/g, the contact area with the surface of the aluminum hydroxide is small and the effect of the reduction of the electric conductivity may be poor. When the BET specific surface area is larger than 300 m²/g, the silica component adsorbs a large amount of moisture and the insulation property may therefore be weakened in contrast.

When the powder silicon compound is used, the means to mix the power silicon compound with the gibbsite-type aluminum hydroxide that is the raw material is not especially limited, and any known mixer may be used such as a Henschel mixer, a V-shaped blender, or an air mixer.

Preferably, when a liquid silicon compound is used, a silicate is used. For example, it is preferred that a monomer of a silicate represented by a general formula Si(OR)₄, wherein R is an alkyl group having 1 or 2 carbon atoms, or a polymer thereof is used. Examples of the monomer include methyl silicate or ethyl silicate. Among these, preferably, methyl silicate is used based on the point that methyl silicate is highly reactive. The polymer thereof such as, preferably, a dimer to a pentamer of methyl silicate or ethyl silicate are used and, more preferably, the dimer to the pentamer of methyl silicate are used.

When a liquid silicon compound is used, the liquid silicon compound may be mixed with the gibbsite-type aluminum hydroxide using a known mixer at a normal temperature and the heating treatment can thereafter be applied to the mixture. The liquid silicon compound may be mixed with the aluminum hydroxide to be the raw material being concurrently heated using, for example, a method in which the liquid silicon compound is added to the gibbsite-type aluminum hydroxide and the liquid silicon compound and the gibbsite-type aluminum hydroxide are mixed with each other being concurrently heated using a stirring mixer such as a Henschel mixer, or a method in which the liquid silicon compound is added to a wet cake of the gibbsite-type aluminum hydroxide and the liquid silicon compound and the gibbsite-type aluminum hydroxide are mixed being concurrently heated at a step of drying the cake. Heating the silicate to a temperature equal to or higher than 100° C. progresses hydrolysis and further progresses condensation of products of the hydrolysis, resulting in precipitation of solid substances on the surface of the aluminum hydroxide. The heating treatment can be applied to the products of the hydrolysis and the condensation (the hydrolysis products and/or the condensation products thereof) of the liquid silicon compound obtained by the above, as the silicon compound. When the mixing is conducted concurrently with the heating, preferably, the mixing is conducted concurrently heating the mixture of the silicon compound and the aluminum hydroxide such that the temperature of the mixture is equal to or higher than 100° C. and equal to or lower than 140° C., to produce mixture powder by removing any solvent component of the silicon compound.

The amount of silicon compound to be added in terms of SiO₂ is preferably equal to or larger than 0.1 part by weight and equal to or lower than 5 parts by weight, and more preferably equal to or larger than 0.3 parts by weight and equal to or smaller than 3 parts by weigh, based on 100 parts by weight of the aluminum hydroxide. Setting the amount of the silicon compound to be added to be in the above ranges enables the electric conductivity to effectively be reduced without forming any aggregate when the silicon compound is mixed with the gibbsite-type aluminum hydroxide.

The method for the heating treatment is not especially limited as long as the water vapor molar fraction is maintained to be equal to or higher than 0.03, and the heating treatment can be conducted using, for example, a hot air dryer or an electric furnace as a static apparatus, or a rotary kiln or a paddle dryer as a flowing-type apparatus. When the heating treatment is conducted using hot air, a water vapor may be included in the hot air to be used. When a rotary kiln or a paddle dryer is used, hot air including a water vapor needs to be blown into the inside of the apparatus. The drying and the heating treatment conducted thereafter can continuously be conducted by introducing a cake or water slurry obtained by filtering and washing the slurry containing the gibbsite-type aluminum hydroxide to be the raw material into the equipment used for the heating treatment. When the heating treatment is applied to the gibbsite-type aluminum hydroxide to be the raw material in the form of the cake or the water slurry containing moisture, the amount of the water vapor to be introduced may be adjusted such that the water vapor molar fraction is equal to or higher than 0.03 and equal to or lower than one, taking into consideration the amount of the moisture originated from the gibbsite-type aluminum hydroxide to be the raw material.

Any known method may be used as the method of including a water vapor in the hot air. The method can be, for example, a method of mixing a water vapor heated at a temperature equal to or higher than 100° C. with hot air and introducing the mixture into the apparatus, and a method of continuously introducing water in the form of a liquid into a heating apparatus and mixing the water with dry hot air in the heating apparatus concurrently evaporating the water in the apparatus.

After the heating treatment, the aluminum hydroxide is separated and collected from the atmosphere including the water vapor, and is dried if necessary. A heat-resistant aluminum hydroxide can thereby be obtained. The aluminum hydroxide produced according to the process of the present invention generally is powder, and the temperature of the powder during the separation and the collection is preferably equal to or higher than 110° C., and more preferably equal to or higher than 120° C. When the temperature of the aluminum hydroxide powder during the separation and the collection is the above temperature, such a phenomenon can be prevented as that a small amount of water vapor accompanying the aluminum hydroxide during the separation becomes droplets on the surface of the powder to increase the amount of adsorbed moisture. The upper limit of the temperature of the powder is not especially limited and generally is about 140° C. When the drying is conducted, the temperature of the powder may be maintained to be equal to or higher than 110° C. and generally equal to or lower than 140° C., and the water vapor may concurrently be removed that accompanies the aluminum hydroxide during the separation and the collection.

Preferably, the gibbsite-type aluminum hydroxide used as the raw material in the process of the present invention is a gibbsite-type aluminum hydroxide powder produced using the Bayer process (hereinafter, also referred to as “raw material powder”). The Bayer process is a method in which a water solution of sodium aluminate in a supersaturation state is produced and aluminum which the water solution contains is precipitated by adding seeds to the water solution. The obtained slurry containing the aluminum hydroxide is washed and dried to obtain the aluminum hydroxide powder. The crystal structure of the obtained aluminum hydroxide is a gibbsite represented by a formula of Al(OH)₃ or Al₂O₃.3H₂O. As mentioned above, the gibbsite-type aluminum hydroxide used as the raw material may also be introduced into the heating treatment equipment in the form of not only the powder but also the cake or the water slurry containing moisture, and the drying and the heating treatment may be continuously applied.

The particle diameter of the raw material powder used in the process of the present invention is preferably equal to or larger than 1 μm and equal to or smaller than 10 μm, and more preferably equal to or larger than 2 μm and equal to or smaller than 5 μm. In the present invention, the average particle diameter of the raw material powder refers to the particle diameter to be at 50% on the volumetric basis in the particle size distribution measured using a laser scattering method. In the case where the particle diameter of the raw material powder is larger than 10 μm, not only the flame retardant property of the resin tends to be degraded when the aluminum hydroxide powder is filled in the resin but also the smoothness of the surface tends to be degraded when the aluminum hydroxide powder is used in an electric cable covering material or a printed circuit board. On the contrary, in the case where the particle diameter is smaller than 1 μm, the viscosity of a resin is increased when the aluminum hydroxide powder is filled in the resin, and production of any resin composition therefrom may be difficult. In addition, the surface area is increased and the amount of moisture adsorbed from the air is increased after the heating treatment. As a result, not only the insulation property of the resin composition is degraded when the aluminum hydroxide powder is filled in the resin but also this small amount of moisture desorbs at the process temperature to conduct the filling thereof into the resin, and the outer appearance may be degraded.

The total content of sodium in the raw material powder in terms of Na₂O is preferably equal to or lower than 0.2% by weight, more preferably equal to or lower than 0.1% by weight, yet more preferably equal to or lower than 0.05% by weight, and is normally equal to or higher than 0.01% by weight. In general, preferably, the content of Na₂O is reduced to enhance the heat resistance of an aluminum hydroxide. On the other hand, preferably, the total content of sodium is small because decomposition is facilitated not only from the outermost surface but also from the inside when a large amount of sodium is included during the heating treatment. The total content of sodium can be measured according to a method of spectroscopic analysis such as that described in, for example, JIS-R9301-3-9.

Preferably, the soluble sodium of the raw material powder is reduced as low as possible. The content of the soluble sodium in the raw material powder in terms of Na₂O is normally equal to or lower than 0.01% by weight, and especially preferably equal to or lower than 0.005% by weight. The content of the soluble sodium can be measured according to a method of spectroscopic analysis such as that described in, for example, JIS-R9301-3-9 after the specimen is soaked in warm water to extract the soluble sodium.

The BET specific surface area of the raw material powder is preferably equal to or larger than 0.5 m²/g and equal to or smaller than 5 m²/g, more preferably equal to or smaller than 4 m²/g, and yet more preferably equal to or smaller than 3 m²/g. When the BET specific surface area of the raw material powder is smaller than 0.5 m²/g, the particle diameter may be large and the BET specific surface area after the heating treatment may be smaller than 1.5 m²/g. On the other hand, when the BET specific surface area of the raw material powder is larger than 5 m²/g, the BET specific surface area after the heating treatment may be larger than 8 m²/g and the amount of the adsorbed moisture from the air may be increased. A heat-resistant aluminum hydroxide can be obtained that can reduce the amount of moisture adsorbed after the heating treatment, that can suppress any degradation of the insulation property acquired by filling thereof in a resin, and, in addition, that can prevent any degradation of the outer appearance caused by the dehydration of moisture originated from the adsorbed moisture at the process temperature to conduct the filling into the resin, by using the raw material powder whose BET specific surface area is in the above ranges.

The heat-resistant aluminum hydroxide of the present invention (hereinafter, also referred to as “the aluminum hydroxide of the present invention”) has few faults associated with the dehydration in the outermost surface. The “faults associated with the dehydration” means herein gap parts generated associated with the desorption of water molecules constituting the crystal of the aluminum hydroxide from the surface of the aluminum hydroxide. The number of faults formed associated with the dehydration can be calculated from the abundance ratio of oxygen atoms (O) to aluminum atoms (Al). Due to the progress of the dehydration, H₂O desorbs and the abundance ratio of O to Al is reduced. The degree of the faults associated with the dehydration can therefore be estimated by measuring the abundance ratio of O to Al in the surface of the aluminum hydroxide. For example, this abundance ratio can be measured using an X-ray photoelectron spectroscopy (hereinafter, also referred to as “XPS”) capable of analyzing at the depth of several nm from the surface of a substance. The area intensity ratio of the peak of oxygen (O1s) to aluminum (Al2p) detected by the XPS measurement (hereinafter, also referred to as “O1s/Al2p area intensity ratio”) is construed as the abundance ratio of oxygen to aluminum. The theoretical intensity ratio is 3 that is acquired when the gibbsite represented by Al(OH)₃ is measured, and the theoretical intensity ratio is 2 for the boehmite represented by AlOOH while the rate of the abundance of oxygen is increased by a rate corresponding to the oxygen atoms originated from the moisture adhering to the surface for the actual measurements thereof. On the other hand, it is inferred for the aluminum hydroxide whose dehydration progresses from the outermost surface thereof due to the heating treatment that the O1s/Al2p area intensity ratio becomes smaller than 3 due to the increase of the faults caused by the desorption of the crystalline water. To what degree the transition of water molecules occurs in the surface at several nm can be estimated by measuring the intensity ratios.

The O1s/Al2p area intensity ratio of the aluminum hydroxide of the present invention measured using the XPS is equal to or greater than 2.55 and equal to or smaller than 2.85, preferably equal to or greater than 2.57 and equal to or smaller than 2.83, and more preferably equal to or greater than 2.60 and equal to or smaller than 2.80. When this O1s/Al2p area intensity ratio is greater than 2.85, no sufficient thermal history is imparted to the aluminum hydroxide and improvement of the heat resistance is limited. On the other hand, in the case where this O1s/Al2p area intensity ratio is smaller than 2.55, even when the thermal history inside the particle is sufficient, a large number of faults are present in the surface of the aluminum hydroxide and the heat resistance is not improved.

Preferably, the aluminum hydroxide of the present invention is in the form of powder. The BET specific surface area of the aluminum hydroxide of the present invention is equal to or larger than 1.5 m²/g and equal to or smaller than 8 m²/g, preferably equal to or larger than 1.5 m²/g and equal to or smaller than 6 m²/g, and more preferably equal to or larger than 1.5 m²/g and equal to or smaller than 5 m²/g. When the BET specific surface area is smaller than 1.5 m²/g, the flame retardant property is degraded. When the BET specific surface area is larger than 8 m²/g, the amount of moisture is increased that is adsorbed from the air after the heating treatment, and not only the insulation property is degraded when the aluminum hydroxide is filled in a resin but also this small amount of moisture desorbs at the process temperature for the filling thereof into the resin resulting in degradation of the outer appearance.

As to the aluminum hydroxide of the present invention, the amount of moisture dehydrated by heating to 100° C. is preferably equal to or smaller than 0.5% by weight, more preferably equal to or smaller than 0.4% by weight, and yet more preferably equal to or smaller than 0.3% by weight. When this amount of moisture exceeds 0.5% by weight, not only the insulation property is degraded but also the faults in the surface are covered with the adsorbed moisture resulting in an apparent increase of the O1s/Al2p intensity ratio. However, the heat resistance is in contrast degraded because the faults in the outermost surface are increased.

The aluminum hydroxide of the present invention has high heat resistance. For example, the aluminum hydroxide does not show the rapid weight reduction in the initial stage of the thermal decomposition called “boehmite shoulder” that is observed with an ordinary gibbsite-type aluminum hydroxide. The aluminum hydroxide of the present invention not only has high heat resistance in the form of powder but also has especially high heat resistance when the aluminum hydroxide is blended in a resin. Because the high thermal history is imparted up to the inside of each particle without increasing any fault in the surface, the temperature is high at which the dehydration starts. For example, the temperature at which the dehydration of the aluminum hydroxide of the present invention starts is about 255° C. in a resin. The aluminum hydroxide can therefore advantageously be blended as a flame retarder even in a resin whose process temperature region is about 230 to 240° C. The temperature at which the dehydration starts can indirectly be evaluated by measuring, using a differential thermogravimetric analyzer, the temperature at which the weight is reduced by 0.3% of an epoxy resin composition formed by blending 150 parts by weight of the aluminum hydroxide in 100 parts by weight of an epoxy resin.

The aluminum hydroxide of the present invention includes a sufficient dehydration amount to function as a flame retarder.

For example, the dehydration amount at the time when the temperature is increased from 100° C. to 400° C. by heating is preferably equal to or larger than 25% by weight, more preferably equal to or larger than 27% by weight, preferably equal to or smaller than 30% by weight, and more preferably equal to or smaller than 29% by weight. When the dehydration amount is smaller than 25% by weight, the function as a flame retarder may be degraded and an additional amount of aluminum hydroxide may need to be blended in the resin composition. The fact that the dehydration amount is reduced up to 400° C. means that the dehydration amount originated from the gibbsite structure is substantially reduced and the transition to alumina progresses, and such an aluminum hydroxide may include increased faults and may have degraded heat resistance.

Preferably, the aluminum hydroxide of the present invention partially includes the boehmite as the crystal structure thereof. This is because a hermetically closed environment is established in each particle even during a heating treatment at the atmospheric pressure and the transition to the boehmite therefore occurs due to the heating treatment. The content of the boehmite which the aluminum hydroxide of the present invention includes is preferably equal to or higher than 3% and equal to or lower than 13%, and more preferably equal to or higher than 6% or equal to or lower than 13%. For the content of the boehmite, areas S(002) and S(020) are acquired, using a powder X-ray diffractometry, of a peak corresponding to the (002) face by a comparison with a JCPDS card 70-2038 (corresponding to the gibbsite) and a peak corresponding to the (020) face of the boehmite by a comparison with a JCPDS card 83-1505 (corresponding to the boehmite). The boemite content is calculated using these two peak areas and the following equation.

Boehmite Content (%)=S(020)/[S(020)+S(002)]×100

The aluminum hydroxide of the present invention can especially efficiently be produced using the process of the present invention.

As to the aluminum hydroxide of the present invention obtained by applying the heating treatment to the gibbsite-type aluminum hydroxide together with the silicon compound, the Na1s bond energy in the surface thereof measured using the X-ray photoelectron spectroscopy has a local maximal value in a range of energy equal to or higher than 1,071.0 eV and equal to or lower than 1,072.0 eV. When the Na1s bond energy is in this range, any desorption can be suppressed of sodium present in the vicinity of the surface from the surface of the aluminum hydroxide as a soluble component. The Na1s bond energy can be measured using the X-ray photoelectron spectroscopy.

The aluminum hydroxide of the present invention having the Na1s bond energy can especially efficiently be produced using the process of the present invention according to which the heating treatment is applied to 100 parts by weight of the gibbsite-type aluminum hydroxide together with the silicon compound of an amount equal to or larger than 0.1 part by weight and equal to or smaller than five parts by weight in terms of SiO₂.

Preferably, the total content of sodium of the aluminum hydroxide of the present invention whose Na1s bond energy has the local maximal value in the range of energy equal to or higher than 1,071.0 eV and equal to or lower than 1,072.0 eV, in terms of Na₂O, is equal to or larger than 0.01% by weight and equal to or smaller than 0.05% by weight. The sodium content of the aluminum hydroxide depends on the sodium content which the gibbsite-type aluminum hydroxide to be the raw material includes, and the sodium content as it is in the raw material gibbsite-type aluminum hydroxide is generally the sodium content of the aluminum hydroxide obtained using the heating treatment.

Therefore, the aluminum hydroxide can be obtained whose total sodium content is in the above range by using the gibbsite-type aluminum hydroxide as the raw material, whose total sodium content converted into the amount of Na₂O is equal to or larger than 0.01% by weight and equal to or smaller than 0.0% by weight.

To improve the affinity with a resin and improve the filling property in a resin, surface treatment may be applied to the aluminum hydroxide of the present invention using a surface treatment agent such as a silane coupling agent, a titanate coupling agent, an aliphatic carboxylic acid such as oleic acid or stearic acid, an aromatic carboxylic acid such as benzoic acid, a fatty acid ester of each of these acids, or a silicate compound such as methyl silicate or ethyl silicate. The surface treatment can be conducted using either a dry or a wet treatment method.

The dry surface treatment method can be, for example, a method of mixing the aluminum hydroxide powder and the surface treatment agent with each other in the Henschel mixer or a Loedige mixer, and a method of putting a mixture of the aluminum hydroxide powder and the surface treatment agent in a crusher to crush these to more evenly coat the surface treatment agent.

The wet surface treatment method can be, for example, a method of dispersing or solving the surface treatment agent into a solvent, dispersing the aluminum hydroxide powder in the resulting solution, and drying the obtained aluminum hydroxide dispersion liquid.

The aluminum hydroxide of the present invention has high heat resistance, includes a small amount of adsorbed moisture, and is suitable as a filling material for various types of resin. The resin may be, for example, a rubber, a thermoplastic resin such as polypropylene or polyethylene, or a thermosetting resin such as an epoxy resin.

A resin composition including the aluminum hydroxide of the present invention can be obtained by mixing the aluminum hydroxide of the present invention and the resin using any known method generally used.

Specific uses of the resin composition formed by blending the aluminum hydroxide of the present invention into any of the various types of resin may be, for example, members such as an electronic part of an electronic device such as a printed circuit board or a prepreg, an electric cable covering material, a polyolefin molding material, a tire, and an architectural material such as artificial marble, and advantageous uses thereof may be parts of electronic devices such as a printed circuit board and a sealant to which high heat resistance is required during processing and use thereof, and an electric cable covering material.

### EXAMPLES

The present invention will be described in more detail with reference to Examples and Comparative Examples presented below.

The measurement was conducted according to the following method for the physical properties of the aluminum hydroxide in Examples and Comparative Examples.

### (1) Average Particle Diameter

A laser scattering particle diameter distribution measuring apparatus [“Microtrac MT-3300EXII” manufactured by Nikkiso Co., Ltd.] was used as the measuring apparatus. The aluminum hydroxide powder was added to a water solution of 0.2% by weight of sodium hexametaphosphate to be prepared to establish a measurable concentration. Thereafter. an ultrasonic wave having output power of 25 W was applied to the solution for 120 sec and then the measurement was conducted with the number of specimens to be 2. The particle diameter and the particle diameter distribution curve were determined from the average value of the values of the two specimens. The average particle diameter was determined as the particle diameter of those corresponding to 50% by weight (D50 (μm)). When the average particle diameter determined using the above method was equal to or smaller than 2 μm, the measurement conditions were changed and the value was employed that was measured after application of an ultrasonic wave having output power of 40 W for 300 sec.

### (2)BET Specific Surface Area

The BET specific surface area was determined using a nitrogen adsorption method and a full-automatic specific surface area measuring apparatus [“Macsorb HM-1201” manufactured by Mountech Co., Ltd.] according to a method defined in JIS-Z-8830.

### (3)Boehmite Content

The boehmite content was measured under the following measurement conditions using a powder X-ray diffraction measuring apparatus [“RINT-2000” manufactured by Rigaku Corporation] and Cu as the X-ray source.

Step Width: 0.02 deg

Scanning Speed: 0.04 deg/sec

Accelerating Voltage: 40 kV

Accelerating Current: 30 mA

The areas S(002) and S(020) were determined of the peak corresponding to the (002) face by comparing the JCPDS card 70-2038 (corresponding to gibbsite) and the peak corresponding to the (020) face of the boehmite by comparing the JCPDS card 83-1505 (corresponding to the boehmite), to the result obtained by measuring under the above measurement conditions. The boehmite content was calculated using the two peak areas and the following equation.

Boehmite Content (%)=S(020)/[S(020)+S(002)]×100

(4)Area Intensity Ratio of Peak of Oxygen (O1s) to That of Aluminum (Al2p) (Hereinafter, “O1s/Al2p”) and Bond Energy of Na1s

These items were measured using an X-ray photoelectron spectroscopy analyzer (“AXIS-ULTRA” manufactured by Kratos Analytical Ltd.). The measurement conditions and the analysis conditions thereof were as follows.

1) Measurement Conditions

X Rays: Alkα (monochrome), 15 kV, 15 mA

Lens Mode: LowMag

Pass Energy: 20 eV

Aperture: SLOT

Neutralizing Gun Charge Balance: 3.5 V

Step: 0.1 eV

Dwell Time: 500 ms

Measured Elements: Al2p, O1s, Na1s, and C1s

Charging Correction: Corrected with C1s=284.6 eV

Sampling: A washer was fixed to a specimen bar using a strip of carbon double-sided tape and the washer was filled with the specimen.

2) Analysis Conditions

Analysis Software: Casa XPS

Analysis Procedure:

Al2p: A background integral intensity was subtracted from the integral intensity of the Al2p peak observed in the range from 70 to 78 eV using a shirley method. The calculated area value was multiplied by an Al2p sensitivity coefficient specific to the apparatus to determine a corrected area intensity.

O1s: A background integral intensity was subtracted from the integral intensity of the O1s peak observed in the range from 526 to 536 eV using the shirley method. The calculated area value was multiplied by an O1s sensitivity coefficient specific to the apparatus to determine a corrected area intensity.

The measurement of the aluminum hydroxide powder was conducted using the above method, and the area intensity ratios of the peaks of oxygen and aluminum of the aluminum hydroxide powder were determined. The O1s/Al2p area intensity ratio was measured twice exchanging the specimens and the value calculated by arithmetically averaging the two values was employed as the measured value.

The energy value indicating a local maximal value of the Na1s peak observed in the range from 1,068 to 1,075 eV was measured twice exchanging the specimens, and the value calculated by arithmetically averaging the two measured values was employed as the local maximal value of the Na1s bond energy.

### (5) Heat Resistance and Dehydration Amount of Aluminum Hydroxide Powder

Using a differential thermogravimetric analyzer [“Thermo Plus TG8120” manufactured by Rigaku Corporation], air whose dew-point temperature was equal to or lower than −20° C. was caused to flow at a flow rate of 100 ml/min for a specimen of about 10 mg, the temperature of the specimen was elevated from the normal temperature to 100° C. at a temperature increase rate of 10° C./min, and the specimen was held at 100° C. for 10 min. Then, the temperature of the specimen was elevated to 400° C. at a temperature increase rate of 10° C./min and the specimen was held at 100° C. for 10 min. The time point at the end of this state was employed as a reference point. The heat resistance was evaluated by measuring a temperature at which the weight is reduced by 0.5% (“Powder TG (° C.)” in Tables 1 and 2 below). The dehydration amount was evaluated using a weight reduced between the time point at which holding the specimen at 100° C. for 10 min comes to an end and the time point at which the temperature reached to 400° C.

### (6)Heat Resistance of Epoxy Resin Composition

100 parts by weight of a bisphenol A epoxy resin [“YD-128” produced by Nippon Steel & Sumikin Chemical Co., Ltd.], 6 parts by weight of dicyandiamide that was a hardening agent for the epoxy resin, 0.2 parts by weight of 2-ethyl 4-methyl imidazole that was a hardening accelerator, 30 parts by weight of dimethyl formaldehyde that was a solvent, and 159.3 parts by weight of the aluminum hydroxide were mixed with each other and the mixture was defoamed by applying an ultrasonic wave for 5 min to produce varnish. The varnish was applied on an aluminum base material using an applicator and was dried at 120° C. for 1 hour to produce a prepreg. Thermal hardening was applied to the prepreg at 170° C. for 1 hour to produce an epoxy resin composition containing 60% by weight of the aluminum hydroxide and having a thickness of 150 μm. The epoxy resin composition was peeled off from the base material and was cut into squares each having sides of each about 2 mm to produce specimens. Using the differential thermogravimetric analyzer [“Thermo Plus TG8120” manufactured by Rigaku Corporation], several of the specimens were stacked on each other to achieve a specimen amount of about 10 mg and air whose dew-point temperature was equal to or lower than −20° C. was caused to flow at a flow rate of 100 ml/min for the specimen. The temperature of the specimen was elevated from the normal temperature to 100° C. at a temperature increase rate of 10° C./min and the specimen was held at 100° C. for 10 min. Thereafter, the temperature of the specimen was elevated to 350° C. at a temperature increase rate of 10° C./min. The time point at which the temperature was 170° C. was employed as another reference point. The heat resistance was evaluated by measuring the temperature at which the weight was reduced by 0.3% (“Epoxy TG (° C.)” in Tables 1 and 2 below).

For an epoxy resin produced by blending alumina having the average particle diameter of 1 μm instead of the aluminum hydroxide and hardening the resin using the above method, the weight reduction thereof at the time point for 170° C. was equal to or smaller than 0.5% and the time point for 170° C. was employed as a reference point. The temperature at which the weight was reduced by 0.3% was 274° C. From this result, it was confirmed that the epoxy resin was not decomposed at the time point at which the epoxy resin composition having the aluminum hydroxide blended therein was reduced by 0.3%.

### (7)Electric Conductivity

10 g of the aluminum hydroxide powder and 50 g of pure water whose electric conductivity was lower than 1 μS/cm were mixed with each other and an ultrasonic wave was applied to the mixture for 10 min to obtain slurry. Using an electric conductivity measuring apparatus [“CM-60S” manufactured by Toa DKK Co., Ltd.], an electrode was soaked in the slurry at 25° C. to be statically put therein for 10 sec and the value determined thereafter was employed as the electric conductivity.

### Example 1

30 g of a gibbsite-type aluminum hydroxide whose average particle diameter was 4.8 μm, whose BET specific surface area was 1 m²/g, and whose Na₂O content was 0.04% by weight [“CL-303” produced by Sumitomo Chemical Co., Ltd.] was put in a hot air dryer whose inner volume was 216 L and whose atmosphere temperature was 230° C., and pure water was supplied thereto at a flow rate of 18 g/min using a tube pump with air concurrently supplied whose dew point was 5° C. at a rate of 0.9 m³/min to conduct a heating treatment for 4 hours at the atmospheric pressure. The water vapor molar fraction in the hot air dryer at 230° C. was 0.03.

After the heating treatment, the dried mixture was taken out of the dryer to obtain aluminum hydroxide powder. The BET specific surface area of the obtained aluminum hydroxide powder was 2.2 m²/g, the boehmite content thereof was 8%, and the O1s/Al2p area intensity ratio thereof was 2.68.

### Example 2

Except that the conditions for the heating treatment in Example 1 were varied as the atmosphere temperature to be 210° C. and the time period of the heating treatment to be 4 hours, aluminum hydroxide powder was obtained using the same method as that of Example 1. The BET specific surface area of the obtained aluminum hydroxide powder was 2.2 m²/g, the boehmite content thereof was 8%, and the O1s/Al2p area intensity ratio thereof was 2.66.

### Example 3

Except that the conditions for the heating treatment in Example 1 were varied as the atmosphere temperature to be 250° C. and the time period of the heating treatment to be 1 hour, aluminum hydroxide powder was obtained using the same method as that of Example 1. The BET specific surface area of the obtained aluminum hydroxide powder was 3.1 m²/g, the boehmite content thereof was 10%, and the O1s/Al2p area intensity ratio thereof was 2.62.

### Example 4

Except that the conditions for the heating treatment in Example 1 were varied as the atmosphere temperature to be 230° C. and the time period of the heating treatment to be 5 hours, aluminum hydroxide powder was obtained using the same method as that of Example 1. The BET specific surface area of the obtained aluminum hydroxide powder was 3.7 m²/g, the boehmite content thereof was 10%, and the O1s/Al2p area intensity ratio thereof was 2.62.

400 g of the gibbsite-type aluminum hydroxide used in Example 1 was put in a cylinder-like heating apparatus whose inner volume was 4 L, and water vaporized into water vapor by heating was supplied thereto at a rate of 28 g/min to conduct a heating treatment at 230° C. for 30 min. The water vapor molar fraction in the heating apparatus was 1.

After the heating treatment, the dried mixture was taken out to obtain aluminum hydroxide powder. The BET specific surface area of the obtained aluminum hydroxide powder was 1.7 m²/g, the boehmite content thereof was 7%, and the O1s/Al2p area intensity ratio thereof was 2.72.

### Example 6

30 g of a gibbsite-type aluminum hydroxide whose average particle diameter was 2.5 μm, whose BET specific surface area was 1.7 m²/g, and whose total sodium content in terms of Na₂O was 0.05% by weight was put in a hot air dryer whose inner volume was 216 L and whose atmosphere temperature was 230° C., and no air was supplied thereto while only pure water was supplied thereto using a tube pump at a rate of 15 g/min to conduct a heating treatment at the atmospheric pressure for 2 hours. The water vapor molar fraction in the hot air dryer at 230° C. was 1.

After the heating treatment, the aluminum hydroxide was taken out of the dryer to obtain aluminum hydroxide powder. The BET specific surface area of the obtained aluminum hydroxide powder was 3.4 m²/g, the boehmite content thereof was 8%, and the O1s/Al2p area intensity ratio thereof was 2.73.

### Example 7

Except that a gibbsite-type aluminum hydroxide whose average particle diameter was 2.4 μm, whose BET specific surface area was 2.5 m²/g, and whose Na₂O content was 0.13% by weight [“C-302A” produced by Sumitomo Chemical Co., Ltd.] was used instead of the gibbsite-type aluminum hydroxide used in Example 6, aluminum hydroxide powder was obtained using the same method as that of Example 6. The BET specific surface area of the obtained aluminum hydroxide powder was 4.5 m²/g, the boehmite content thereof was 9%, and the O1s/Al2p area intensity ratio thereof was 2.65.

### Example 8

Except that a gibbsite-type aluminum hydroxide whose average particle diameter was 1.2 μm, whose BET specific surface area was 4.3 m²/g, and whose Na₂O content was 0.20% by weight [“C-301N” produced by Sumitomo Chemical Co., Ltd.] was used instead of the gibbsite-type aluminum hydroxide used in Example 6, aluminum hydroxide powder was obtained using the same method as that of Example 6. The BET specific surface area of the obtained aluminum hydroxide powder was 6.8 m²/g, the boehmite content thereof was 6%, and the O1s/Al2p area intensity ratio thereof was 2.79.

### Example 9

100 parts by weight of the gibbsite-type aluminum hydroxide whose average particle diameter was 4.8 μm, whose BET specific surface area was 1 m²/g, and whose Na₂O content was 0.04% by weight [“CL-303” produced by Sumitomo Chemical Co., Ltd.], 10 parts by weight of pure water, and 0.7 parts by weight of methyl silicate [“MS-51” produced by Mitsubishi Chemical Corporation, whose silicon content in terms of SiO₂ was 51% by weight] were mixed with each other and the mixture was dried in a hot air dryer maintained at 140° C. for 5 hours. Then, 30 g of this mixture powder was put in a hot air dryer whose inner volume was 216 L and whose atmosphere temperature was 230° C., and pure water was supplied thereto at a flow rate of 18 g/min using a tube pump with air whose dew point was 5° C. concurrently supplied at a flow rate of 0.9 m³/min to conduct a heating treatment for 4 hours. The water vapor molar fraction in the hot air dryer at 230° C. was 0.03.

After the heating treatment, the dried mixture was taken out of the dryer to obtain aluminum hydroxide powder. The BET specific surface area of the obtained aluminum hydroxide powder was 2.5 m²/g, the boehmite content thereof was 8%, and Na1s bond energy thereof was 1,071.4 eV.

### Example 10

100 parts by weight of a gibbsite-type aluminum hydroxide whose average particle diameter was 2.4 μm, whose BET specific surface area was 2.5 m²/g, and whose Na₂O content was 0.13% by weight [“C-302A” produced by Sumitomo Chemical Co., Ltd.] instead of the gibbsite-type aluminum hydroxide used in Example 10, 40 parts by weight of pure water, and 1.8 parts by weight of methyl silicate [“MS-51” produced by Mitsubishi Chemical Corporation, whose silicon content in terms of SiO₂ was 51% by weight] were mixed with each other and the mixture was dried in a hot air dryer maintained at 140° C. for 5 hours. This powder was applied with a heating treatment using the same method as that of Example 6 to thereby obtain aluminum hydroxide powder. The BET specific surface area of the obtained aluminum hydroxide powder was 6.5 m²/g, the boehmite content thereof was 8%, and Na1s bond energy thereof was 1,071.1 eV.

### Example 11

100 parts by weight of a gibbsite-type aluminum hydroxide whose average particle diameter was 1.2 μm, whose BET specific surface area was 4.3 m²/g, and whose Na₂O content was 0.20% by weight [“C-301N” produced by Sumitomo Chemical Co., Ltd.], 40 parts by weight of pure water, and 3.2 parts by weight of methyl silicate [“MS-51” produced by Mitsubishi Chemical Corporation, whose silicon content in terms of SiO₂ was 51% by weight] were mixed with each other and the mixture was dried in a hot air dryer maintained at 140° C. for 5 hours. This powder was applied with a heating treatment using the same method as that of Example 6 to obtain aluminum hydroxide powder. The BET specific surface area of the obtained aluminum hydroxide powder was 6.5 m²/g, the boehmite content thereof was 6%, and Na1s bond energy thereof was 1,071.2 eV.

### Comparative Example 1

30 g of the gibbsite-type aluminum hydroxide whose average particle diameter was 4.8 μm, whose BET specific surface area was 1 m²/g, and whose Na₂O content was 0.04% by weight [“CL-303” produced by Sumitomo Chemical Co., Ltd.] was put in a hot air dryer whose inner volume was 216 L and whose atmosphere temperature was 210° C., and air whose dew point was 5° C. was supplied thereto at a rate of 0.9 m³/min to conduct a heating treatment for 4 hours at the atmospheric pressure. The water vapor molar fraction in the hot air dryer at 210° C. was 0.01.

After the heating treatment for 4 hours in the dryer, the aluminum hydroxide was taken out of the dryer to obtain aluminum hydroxide powder. The BET specific surface area of the obtained aluminum hydroxide powder was 1.2 m²/g, the boehmite content thereof was 5%, and the O1s/Al2p area intensity ratio thereof was 2.87.

### Comparative Example 2

Except that the conditions for the heating treatment in Comparative Example 1 were varied as the atmosphere temperature to be 230° C. and the time period of the heating treatment to be 2 hours, aluminum hydroxide powder was obtained using the same method as that of Comparative Example 1. The BET specific surface area of the obtained aluminum hydroxide powder was 2.0 m²/g, the boehmite content thereof was 6%, and the O1s/Al2p area intensity ratio thereof was 2.48.

### Comparative Example 3

Except that the conditions for the heating treatment in Comparative Example 1 were varied as the atmosphere temperature to be 240° C. and the time period of the heating treatment to be 35 min, aluminum hydroxide powder was obtained using the same method as that of Comparative Example 1. The BET specific surface area of the obtained aluminum hydroxide powder was 3.1 m²/g, the boehmite content thereof was 7%, and the O1s/Al2p area intensity ratio thereof was 2.48.

### Comparative Example 4

Except that the conditions for the heating treatment in Comparative Example 1 were varied as the atmosphere temperature to be 240° C. and the time period of the heating treatment to be 2 hours, aluminum hydroxide powder was obtained using the same method as that of Comparative Example 1. The BET specific surface area of the obtained aluminum hydroxide powder was 3.7 m²/g, the boehmite content thereof was 8%, and the O1s/Al2p area intensity ratio thereof was 2.52.

### Comparative Example 5

Except that the conditions for the heating treatment in Comparative Example 1 were varied as the atmosphere temperature to be 260° C. and the time period of the heating treatment to be 1 hour, aluminum hydroxide powder was obtained using the same method as that of Comparative Example 1. The BET specific surface area of the obtained aluminum hydroxide powder was 6.5 m²/g, the boehmite content thereof was 8%, and the O1s/Al2p area intensity ratio thereof was 2.51.

### Comparative Example 6

100 parts by weight of a gibbsite-type aluminum hydroxide whose average particle diameter was 5.2 μm, whose BET specific surface area was 0.8 m²/g, and whose Na₂O content was 0.04% by weight and 200 parts by weight of pure water were mixed with each other and the mixture was put in a SUS autoclave whose inner volume was 1 L to conduct a heating treatment at 180° C. for 2 hours. Slurry after undergoing the hydrothermal process was collected and was applied with solid-liquid separation by suction filtering. Then the slurry was statically put to be dried in an oven at 120° C. for 8 hours to obtain aluminum hydroxide powder. The BET specific surface area of the obtained aluminum hydroxide was 0.8 m²/g, the boehmite content thereof was 7%, and the O1s/Al2p area intensity ratio thereof was 2.78.

### Comparative Example 7

Except that the conditions for the heating treatment in Comparative Example 1 were varied as the atmosphere temperature to be 230° C. and the time period of the heating treatment to be 4 hours, aluminum hydroxide powder was obtained using the same method as that of Comparative Example 1. The BET specific surface area of the obtained aluminum hydroxide powder was 89 m²/g and the boehmite content thereof was 12%.

### Comparative Example 8

Except that a heating treatment was conducted without supplying any pure water and any air, aluminum hydroxide powder was obtained using the same method as that of Example 9. The BET specific surface area of the obtained aluminum hydroxide powder was 89 m²/g and the boehmite content thereof was 13%.

### (Heat Resistance of Powder, Epoxy Resin Composition)

Evaluation results for the aluminum hydroxide powder obtained in each of Examples and Comparative Examples, and evaluation results of the gibbsite-type aluminum hydroxide used as the raw material in Example 1 (Comparative Example 9) are shown in Tables 1 and 2.

### (Variation Amount of Electric Conductivity Due to Heating)

### Reference Example 1

10 g of the aluminum hydroxide powder obtained in Example 7 and 20 g of pure water whose electric conductivity was lower than 1 μS/cm were put in a SUS container whose inner volume was 50 ml and the SUS container was sealed up to prevent the water from evaporating. The SUS container was heated in an oven at 140° C. for 24 hours. After cooling the container to the room temperature, the container was opened and the all amount of slurry in the container was washed with 30 g of pure water and collected the slurry. Total weight of the obtained slurry was 60 g. Using an electric conductivity measuring apparatus [“CM-60S” manufactured by Toa DKK Co., Ltd.], an electrode was soaked in the slurry at a temperature of 25° C. to be statically put therein for 10 sec and then the determined value was recorded.

### Reference Example 2

Except that the aluminum hydroxide powder obtained in Example 10 was used, the heating treatment and the electric conductivity measurement were conducted in the same procedures as those of Reference Example 1.

The electric conductivity of the aluminum hydroxide powder of each of Example 7 and Example 10 (in the table, “Before Heating Treatment”) and the electric conductivity of the aluminum hydroxide powder of each of Reference Examples 1 and 2 (in the table, “After Heating Treatment”) are shown in Table 3.

TABLE 1

| | | Example | | | | | | | | | | |
|---|---|---|---|---|---|---|---|---|---|---|---|---|
| | | 1 | 2 | 3 | 4 | 5 | 6 | 7 | 8 | 9 | 10 | 11 |
| Powder TG | ° C. | 243 | 241 | 242 | 243 | 242 | 242 | 236 | 232 | 241 | 237 | 233 |
| Epoxy TG | ° C. | 258 | 257 | 254 | 257 | 256 | 253 | 251 | — | 257 | 257 | — |
| O1s/Al2p | — | 2.68 | 2.66 | 2.62 | 2.62 | 2.72 | 2.73 | 2.65 | 2.79 | — | — | — |
| Na1s Bond | eV | 1070.6 | 1070.7 | 1070.6 | 1070.6 | 1070.6 | 1070.6 | 1070.7 | 1070.6 | 1071.4 | 1071.1 | 1071.2 |
| Energy (Local | | | | | | | | | | | | |
| Maximal value) | | | | | | | | | | | | |
| BET | m²/g | 2.2 | 2.2 | 3.1 | 3.7 | 1.7 | 3.4 | 4.5 | 6.8 | 2.5 | 6.5 | 6.5 |
| Electric | μS/cm | 62 | 51 | 65 | 71 | 36 | 74 | 179 | 335 | 20 | 79 | 131 |
| Conductivity | | | | | | | | | | | | |
| Dehydration | % | 28.9 | 28.7 | 28.1 | 28.2 | 29.1 | 28.7 | 29.0 | 28.7 | 28.9 | 28.8 | 29.1 |
| Amount | | | | | | | | | | | | |
| Boehmite | % | 8 | 8 | 10 | 10 | 7 | 8 | 9 | 6 | 8 | 8 | 6 |
| Content | | | | | | | | | | | | |

TABLE 2

| | | Comparative Example | | | | | | | | |
|---|---|---|---|---|---|---|---|---|---|---|
| | | 1 | 2 | 3 | 4 | 5 | 6 | 7 | 8 | 9 |
| Powder TG | ° C. | 240 | 239 | 239 | 239 | 241 | 240 | 157 | — | 236 |
| Epoxy TG | ° C. | 249 | 250 | 250 | 251 | 250 | 245 | — | — | 237 |
| O1s/Al2p | — | 2.87 | 2.48 | 2.48 | 2.52 | 2.51 | 2.78 | — | — | 3.06 |
| Na1s Bond | eV | 1070.6 | 1070.6 | 1070.6 | 1070.6 | 1070.8 | 1070.6 | — | — | 1070.7 |
| Energy (Local | | | | | | | | | | |
| Maximal Value) | | | | | | | | | | |
| BET | m²/g | 1.2 | 2.0 | 3.1 | 3.7 | 6.5 | 0.8 | 89 | 89 | 1.0 |
| Dehydration | % | 29.5 | 29.0 | 29.2 | 28.7 | 28.4 | 28.4 | — | — | 30.8 |
| Amount | | | | | | | | | | |
| Boehmite | % | 5 | 6 | 7 | 8 | 8 | 7 | 12 | 13 | 0 |
| Content | | | | | | | | | | |

TABLE 3

Reference Example

| | | 1 | 2 |
|---|---|---|---|
| Before | μS/cm | 179 | 79 |
| Heating | | (Example 7) | (Example 10) |
| Treatment | | | |
| After | μS/cm | 295 | 100 |
| Heating | | | |
| Treatment | | | |

From the above results, it was confirmed that the aluminum hydroxide powder produced using the process of the present invention had high heat resistance suppressing the faults in the surface thereof. In addition, it was confirmed that the aluminum hydroxide powder produced using the process of the present invention had high heat resistance even when the aluminum hydroxide powder was blended in an epoxy resin. It also was confirmed that the electric conductivity of the aluminum hydroxide powder was able to be reduced maintaining the high heat resistance by causing a silicon compound to coexist therewith.

### INDUSTRIAL APPLICABILITY

According to the production process of the present invention, a high thermal history can be imparted to the aluminum hydroxide suppressing any fault and any dehydration in the surface thereof, and the aluminum hydroxide that has highly heat-resistant and is tolerant to the process temperature of a resin can be produced.

1. A process for producing a heat-resistant aluminum hydroxide, comprising the step of
applying a heating treatment to a gibbsite-type aluminum hydroxide at a pressure equal to or higher than an atmospheric pressure and equal to or lower than 0.3 MPa, in an atmosphere whose water vapor molar fraction is equal to or higher than 0.03 and equal to or lower than 1, and at a temperature equal to or higher than 180° C. and equal to or lower than 300° C.

2. The process according to claim 1, wherein the gibbsite-type aluminum hydroxide is produced using a Bayer process.

3. The process according to claim 1, wherein a time period to conduct the heating treatment is equal to or longer than 1 min and equal to or shorter than 360 min.

4. The process according to claim 1, wherein the heating treatment is applied to 100 parts by weight of the gibbsite-type aluminum hydroxide together with 0.1 part by weight or more and 5 parts by weight or less of silicon compound in terms of SiO₂.

5. The process according to claim 4, wherein the silicon compound is a monomer of a silicate represented by a general formula Si(OR)₄,
wherein R is an alkyl group having 1 or 2 carbon atoms, a polymer thereof, or a hydrolysis product and/or a condensation product thereof.

6. A heat-resistant aluminum hydroxide, wherein BET specific surface area is equal to or larger than 1.5 m²/g and equal to or smaller than 8 m²/g, and area intensity ratio of oxygen and aluminum (O1s/Al2p) measured using an X-ray photoelectron spectroscopy is equal to or greater than 2.55 and equal to or smaller than 2.85.

7. The heat-resistant aluminum hydroxide according to claim 6, wherein
a boehmite content is equal to or higher than 3% and equal to or lower than 13%.

8. A heat-resistant aluminum hydroxide, wherein BET specific surface area is equal to or larger than 1.5 m²/g and equal to or smaller than 8 m²/g, a boehmite content is equal to or higher than 3% and equal to or lower than 13%, and whose Na1s bond energy in a surface thereof measured using an X-ray photoelectron spectroscopy has a local maximal value in a range equal to or higher than 1,071.0 eV and equal to or lower than 1,072.0 eV.

9. The heat-resistant aluminum hydroxide according to claim 8, wherein
a total sodium content in terms of Na₂O is equal to or higher than 0.01% by weight and equal to or lower than 0.05% by weight.

10. A resin composition comprising the heat-resistant aluminum hydroxide according to claim 6.
